(19) United States
(12) Patent Application Publication
(10) Pub. No.: US 2020/0363825 A1
(43) Pub. Date: Nov. 19, 2020

(54) PICKUP SYSTEM

(71) Applicant: DENSO CORPORATION, Kariya-city (JP)

(72) Inventor: Hisamichi AOKI, Kariya-city (JP)

(21) Appl. No.: 16/983,942

(22) Filed: Aug. 3, 2020

Related U.S. Application Data
(63) Continuation of application No. PCT/JP2018/046564, filed on Dec. 18, 2018.

(30) Foreign Application Priority Data
Feb. 9, 2018 (JP) 2018-021959

(51) Int. Cl. G05D 1/12; G06Q 50/30; G06Q 30/00; G01C 21/34; G05D 1/00; G05D 1/10; B64C 39/02; G06K 9/00; H04N 7/18

(52) U.S. Cl. CPC G05D 1/12; G06Q 50/30; G06Q 30/0185; G01C 21/3407; G05D 1/0088; G05D 1/0094; B64C 2201/141; B64C 39/024; G06K 9/00288; H04N 7/185; G05D 2201/0213; B64C 2201/027; G05D 1/101

(57) ABSTRACT

A pickup system includes a vehicle dispatch center communicating with a mobile terminal carried by a customer, an autonomous vehicle, and a drone mounted on the autonomous vehicle. When a request to pick up the customer is inputted to the mobile terminal, the mobile terminal transmits a pickup request to the vehicle dispatch center. The vehicle dispatch center transmits a pickup command to the autonomous vehicle, and the autonomous vehicle transmits the pickup command to the drone. The autonomous vehicle autonomously drives to a position where a parking is allowed close to the customer, stops at the position, and launches the drone. The drone moves close to the customer, recognizes a face image captured by a camera to detect the customer, and guides the customer to the autonomous vehicle.

### CROSS REFERENCE TO RELATED APPLICATIONS

The present application is a continuation application of International Patent Application No. PCT/JP2018/046564 filed on Dec. 18, 2018, which designated the U.S. and claims the benefit of priority from Japanese Patent Application No. 2018-021959 filed on Feb. 9, 2018. The entire disclosures of all of the above applications are incorporated herein by reference.

### TECHNICAL FIELD

The present disclosure relates to a pickup system.

### BACKGROUND

There has been known a pickup system using an autonomous vehicle.

### SUMMARY

The present disclosure provides a pickup system including a vehicle dispatch center communicating with a mobile terminal carried by a customer, an autonomous vehicle, and a drone mounted on the autonomous vehicle. When a request to pick up the customer is inputted to the mobile terminal, the mobile terminal transmits a pickup request to the vehicle dispatch center. The vehicle dispatch center transmits a pickup command to the autonomous vehicle, and the autonomous vehicle transmits the pickup command to the drone. The autonomous vehicle autonomously drives to a position where a parking is allowed close to the customer, stops at the position, and launches the drone. The drone moves close to the customer, recognizes a face image captured by a camera to detect the customer, and guides the customer to the autonomous vehicle.

### BRIEF DESCRIPTION OF DRAWINGS

Objects, features and advantages of the present disclosure will become apparent from the following detailed description made with reference to the accompanying drawings. In the drawings:

FIG. 1 is a block diagram showing a schematic configuration of a pickup system according to a first embodiment;

FIG. 2 is a block diagram of an onboard apparatus and the like;

FIG. 3 is a perspective view of a drone;

FIG. 4 is a block diagram of the drone;

FIG. 5 is a flowchart showing a control of a customer direction calculation function and an obstacle avoidance function;

FIG. 6 is a flowchart showing a control of a customer identification function;

FIG. 7 is a flowchart showing a control of a customer lead function; and

FIG. 8 is a flowchart showing a control when the customer cannot be detected.

### DETAILED DESCRIPTION

There is a method which delivers a cargo using an unmanned carrying device. In this method, an autonomous vehicle carrying the cargo moves to a vicinity of an accommodation container where the cargo is delivered to, and a drone mounted on the autonomous driving vehicle is controlled to fly from the autonomous vehicle to the accommodation container so that the cargo is delivered to the accommodation container by the drone.

In the method described above, the cargo is delivered to a predetermined place by the autonomous vehicle or the like. The inventor of the present disclosure conceives of a system that controls an autonomous vehicle to reach an unspecified number of customers, picks the customers up, and guides the customers to the autonomous vehicle for boarding.

A pickup system according to an aspect of the present disclosure includes a vehicle dispatch center communicating with a mobile terminal carried by a customer, an autonomous vehicle communicating with the vehicle dispatch center, and a drone mounted on the autonomous vehicle, communicating with the autonomous vehicle, and having a camera. When a request to pick up the customer is inputted to the mobile terminal carried by the customer, the mobile terminal transmits, to the vehicle dispatch center, a pickup request of the customer, position information of the customer, and face image information of the customer. The vehicle dispatch center transmits, to the autonomous vehicle, a pickup command of the customer, the position information of the customer, and the face image information of the customer. The autonomous vehicle transmits, to the drone, the pickup command of the customer, the position information of the customer, and the face image information of the customer. The autonomous vehicle autonomously drives to a position where a parking of the autonomous vehicle is allowed close to the customer, stops at the position, and launches the drone. The drone moves close to the customer, recognizes a face image captured by the camera to detect the customer, and guides the customer that is detected to the autonomous vehicle.

### First Embodiment

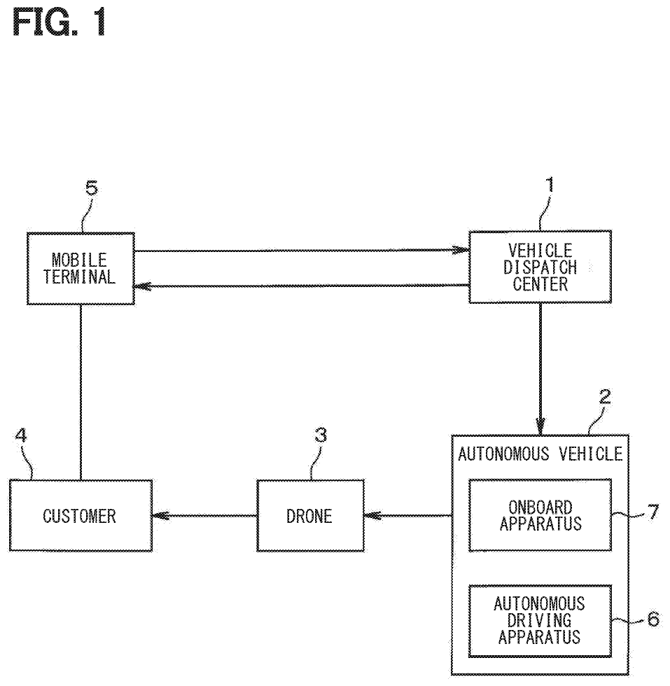

A first embodiment will be described with reference to FIG. 1 to FIG. 8. As shown in FIG. 1, a pickup system according to the present embodiment includes a vehicle dispatch center 1, an autonomous vehicle 2, and a drone 3 mounted on the autonomous vehicle 2. The vehicle dispatch center 1 is configured to be able to wirelessly communicate with one or more mobile terminals 5 and one or more autonomous vehicles 2. The mobile terminals 5 are owned by an unspecified number of customers 4.

The vehicle dispatch center 1 has a function of receiving a pickup request from the customer 4 via the mobile terminal 5, a function of giving a movement command for pickup to the autonomous vehicle 2, a function of managing the operation of the autonomous vehicle 2, and the like. The mobile terminal 5 is configured by, for example, a smartphone, a tablet, a cellular phone, or the like. The customer 4 operates the mobile terminal 5 to request the vehicle dispatch center 1 to pick the customer 4 up. The application software for requesting a pickup may be downloaded to the mobile terminal 5 in advance, and the application software is activated to perform the pickup request when the customer 4 operates the mobile terminal 5.

The autonomous vehicle 2 has a function of performing autonomous driving, a function of picking the customer 4 up, a function of boarding and carrying the customer 4, a function of wirelessly communicating with the vehicle dispatch center 1, a function of wirelessly communicating with the mobile terminal 5 of the customer 4, and a function of wirelessly communicating with the drone 3. The autonomous vehicle 2 includes an autonomous driving apparatus 6 and an onboard apparatus 7. The autonomous driving apparatus 6 has a function of autonomously driving the autonomous vehicle 2, and when receiving the movement command and the movement position from the onboard apparatus 7, the autonomous driving apparatus 6 moves the autonomous vehicle 2 to the received movement position by the autonomous driving, and stops the autonomous vehicle 2. The autonomous driving apparatus 6 is preferably configured by an autonomous driving apparatus or the like having a well-known configuration.

The onboard apparatus 7 has a function of wirelessly communicating with the vehicle dispatch center 1, a function of wirelessly communicating with the mobile terminal 5 of the customer 4, a function of wirelessly communicating with the drone 3, and the like. The onboard apparatus 7 receives, from the vehicle dispatch center 1, a pickup command of the customer 4, position information of the customer 4, identification information of the customer 4, for example, a face image of the customer 4, and information of the mobile terminal 5 of the customer 4, for example, a mail address, a telephone number, and the like. The onboard apparatus 7 transmits the movement command and the movement position to the autonomous driving apparatus 6. The onboard apparatus 7 transmits the pickup command of the customer 4, the position information of the customer 4, the face image of the customer 4, and the like to the drone 3. A specific configuration of the onboard apparatus 7 will be described later.

The drone 3 has a function of flying to the customer 4, detecting the customer 4, and leading the customer 4 to a parking position of the autonomous vehicle 2. The drone 3 receives the pickup command of the customer 4, the position information of the customer 4, information of the face image of the customer 4, and the like from the onboard apparatus 7. A specific configuration of the drone 3 will be described later.

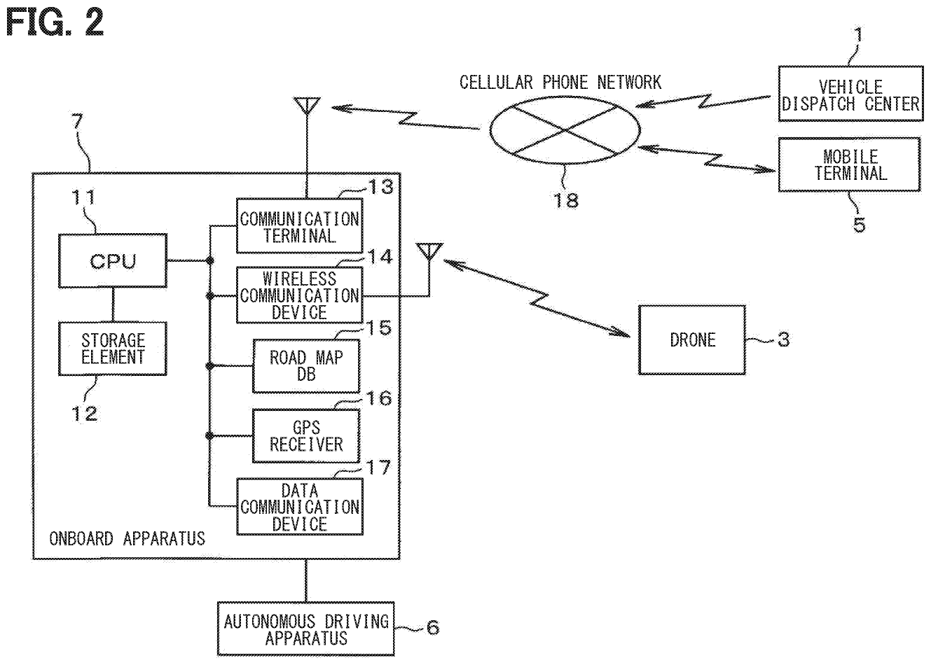

As shown in FIG. 2, the onboard apparatus 7 includes a CPU 11, a storage element 12, a communication terminal 13, a wireless communication device 14, a road map database 15, a GPS receiver 16, a data communication device 17, and the like. The storage element 12 includes, for example, a ROM, a RAM, a flash memory, and the like, and stores a control program, various data, and the like. The communication terminal 13 has a function of communicating with a wireless communication network, for example, a cellular phone network 18, and communicates with the vehicle dispatch center 1, the mobile terminal 5 of the customer 4, and the like via the cellular phone network 18.

The wireless communication device 14 has a function of performing a wireless communication with the drone 3. The road map database 15 includes, for example, a hard disk, a DVD, a flash memory, and the like, and stores road map data for route search and route guidance. The road map database 15 may be configured to be acquired by a communication with an external server via the communication terminal 13. The GPS receiver 16 has a function of detecting the current position of the autonomous vehicle 2 based on a GPS reception signal. The data communication device 17 has a function of communicating with the autonomous driving apparatus 6.

The onboard apparatus 7 realizes the following functions by causing the CPU 11 to execute the control program in the storage element 12.

The onboard apparatus 7 receives a pickup command of the customer 4 and customer information from the vehicle dispatch center 1 via the cellular phone network 18 and the communication terminal 13. The customer information includes the position information of the customer 4, the face image of the customer 4, the mail address and the telephone number of the mobile terminal 5 of the customer 4, and the like.

The onboard apparatus 7 calculates a position to which the autonomous vehicle 2 moves based on the customer position information and the road map database 15, and transmits the calculated movement position information and the movement command to the autonomous driving apparatus 6 via the data communication device 17.

The onboard apparatus 7 transmits the pickup command of the customer 4 and the customer information to the drone 3 via the wireless communication device 14.

The onboard apparatus 7 calculates route guidance information calculates a route to guide the customer 4 to the autonomous vehicle 2, that is, a customer guide route and a route guidance information to guide along the guide route based on the road map database 15 and position information of the drone 3 received from the drone 3 via the wireless communication device 14, that is, the position information of the customer 4. The onboard apparatus 7 then transmits the calculated customer guide route information and route guidance information to the drone 3 via the wireless communication device 14.

When receiving a request to transmit an “arrival notice” to the customer, from the drone 3 via the wireless communication device 14, the onboard apparatus 7 transmits a message indicating that the drone 3 has arrived at the customer 4 to the mobile terminal 5 of the customer 4 via the communication terminal 13, and waits for a reply from the customer 4. When receiving the reply from the customer 4, the onboard apparatus 7 transmits a command to search the customer 4 again to the drone 3 via the wireless communication device 14. When there is no reply from the customer 4, the onboard apparatus 7 transmits a message indicating that the pickup request has been canceled to the customer 4 via the communication terminal 13, and transmits to the drone 3 a command to return to the autonomous vehicle 2 and the position information of the autonomous vehicle 2.

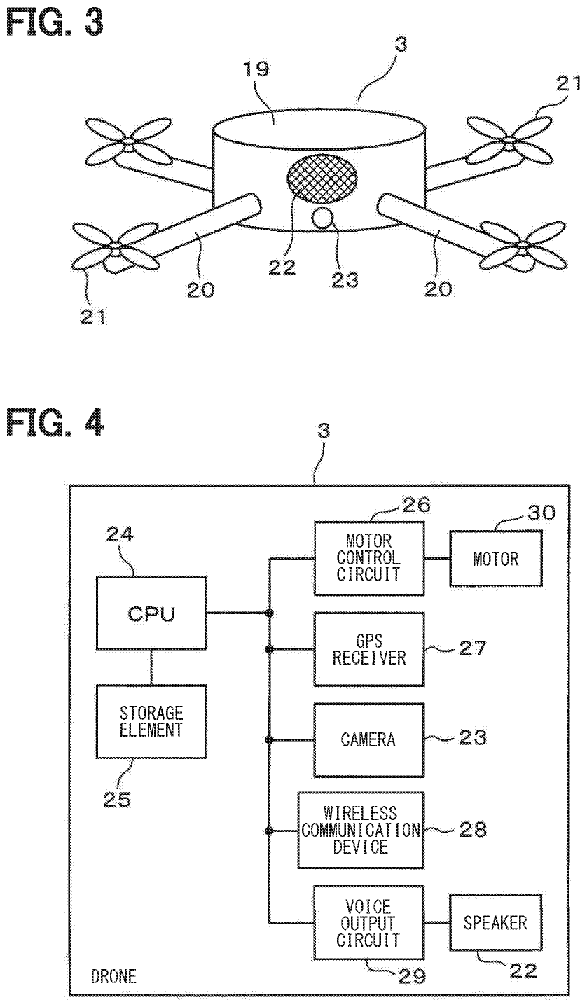

As shown in FIG. 3, the drone 3 includes a main body 19, four arms 20 protruding from the main body 19, and propellers 21 provided at tip portions of the respective arms 20. A speaker 22 and a camera 23 are disposed on a side surface of the main body 19. As shown in FIG. 4, the drone 3 includes a CPU 24, a storage element 25, a motor control circuit 26, a GPS receiver 27, cameras 23, a wireless communication device 28, a voice output circuit 29, and the like. The storage element 12 includes, for example, a ROM, a RAM, a flash memory, and the like, and stores a control program, various data, and the like.

The motor control circuit 26 controls the four motors 30 that rotate the four propellers 21, separately. The GPS receiver 27 has a function of detecting the current position of the drone 3. The camera 23 captures an image of the periphery of the drone 3, and has a function of capturing an image of a face of a person who comes close to the drone 3. The wireless communication device 28 has a function of performing a wireless communication with the onboard apparatus 7. The audio output circuit 29 generates various voice messages, and outputs the generated voice messages from the speaker 22.

The drone 3 realizes the following functions by causing the CPU 24 to execute the control program in the storage element 25.

The drone 3 rotationally controls the four motors 30 via the motor control circuit 26 to fly.

The GPS receiver 27 detects the current position of the drone 3.

The drone 3 performs an image recognition processing is performed on the image information captured by the camera 23 to recognize the face image of a person in the vicinity, and compares the recognized face image with the face image of the customer 4, to thereby detect, that is, identify, the customer 4.

The drone 3 executes the image recognition processing on the image information captured by the camera 23, to thereby recognize the obstacle and detect the obstacle existing in a traveling direction of flight of the drone 3.

The drone 3 communicates with the onboard apparatus 7 via the wireless communication device 28.

The drone 3 receives information on the guide route for guiding the customer 4 from the onboard apparatus 7 via the wireless communication device 28 and the route guidance information as necessary, and leads the customer 4 and returns to the autonomous vehicle 2 while flying along the guidance route in accordance with the current position of the drone 3.

The drone 3 outputs a voice message for route guidance to the customer 4 via the voice output circuit 29 and the speaker 22, that is, speaks to the customer 4.

The operation of the above-described configuration, that is, the operation of receiving a request from the customer 4 and picking up the customer 4 by the autonomous vehicle 2 will be described with reference to FIG. 1.

(1) Customer Request

The customer 4 who requests the pickup of the autonomous vehicle 2 operates the mobile terminal 5 to launch application software, and transmits a “pickup request” from the mobile terminal 5 to the vehicle dispatch center 1. The transmission information includes the position information detected by the mobile terminal 5, that is, the position information of the customer 4 and the image information of the face of the customer 4 captured by the mobile terminal 5.

(2) Request Permission

The vehicle dispatch center 1 that has received the “pickup request” transmits a message indicating that the request has been permitted to the mobile terminal 5 of the customer.

(3) Command from the vehicle dispatch center 1 to the onboard apparatus 7

The vehicle dispatch center 1 selects the autonomous vehicle 2 to be dispatched, and transmits the position information of the customer 4, the face image information of the customer 4, and the pickup command to the onboard apparatus 7 mounted on the autonomous vehicle 2.

(4) Movement Command

The onboard apparatus 7 that has received the pickup command calculates a road position or a parking position, that is, moving position information, at which the autonomous vehicle 2 can stop and which is as close as possible to the customer 4, based on the road map database 15 and the received position information of the customer 4. Then, the onboard apparatus 7 transmits the movement position information and the movement command to the autonomous driving apparatus 6.

(5) Customer Pickup Command

The onboard apparatus 7 transmits the position information of the customer 4, the face image information of the customer 4, and the pickup command of the customer 4 to the drone 3 mounted on the autonomous vehicle 2.

(6) Customer Pickup

The drone 3 that has received the customer pickup command jumps from the autonomous vehicle 2, and flies in the direction in which the customer 4 is located based on the received position information of the customer 4. Then, the drone 3 recognizes the customer 4, that is, upon detection of the customer 4, the drone 3 speaks to the customer 4 about an arrival for pickup via the speaker 22. In addition, the drone 3 hovers slightly ahead of the customer 4, and returns to the autonomous vehicle 2 while giving route guidance to the customer 4 by voice via the speaker 22.

Next, in order to realize the customer pickup function (6) by the drone 3, the drone 3 has the following functions.
Customer direction calculation function
Obstacle avoidance function
Customer identification function
Customer lead function
Arrival notice function

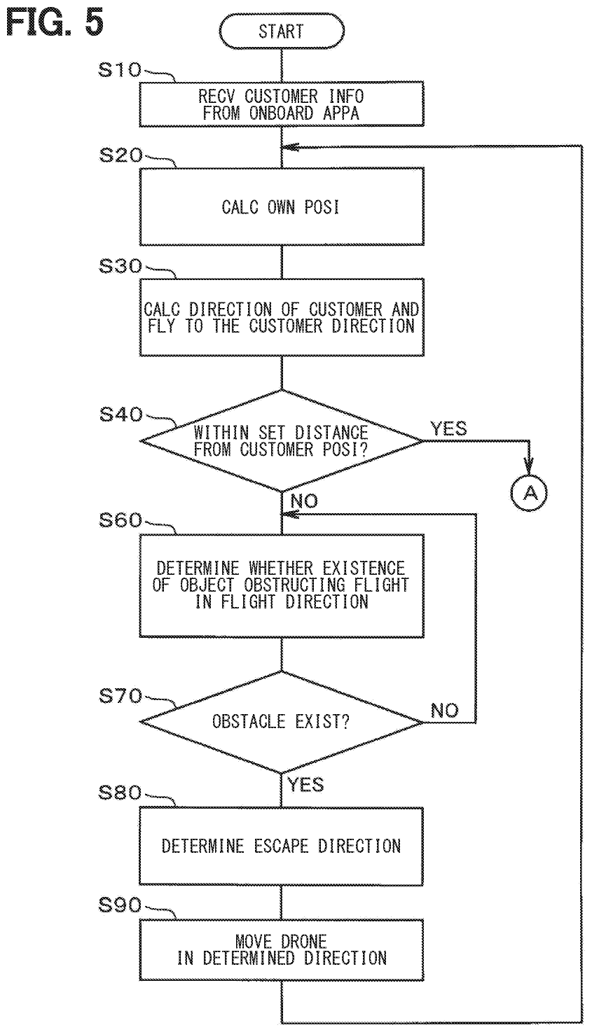

The customer direction calculation function, that is, the function of calculating the direction in which the customer 4 is located, and the obstacle avoidance function, that is, the function of avoiding an obstacle when the obstacle is detected in the flight route to the customer, will be described with reference to a flowchart of FIG. 5. The flowchart of FIG. 5 shows the content of the control of the drone 3.

In S10 of FIG. 5, the drone 3 receives the position information of the customer 4 from the onboard apparatus 7. Subsequently, the flow proceeds to S20, and the drone 3 detects the own current position by the position calculation function of the own GPS receiver 27. Then, the flow proceeds to S30, where the drone 3 calculates the direction of the customer 4 according to the position of the drone 3 and the position of the customer 4, and flies toward the calculated direction.

Thereafter, the flow proceeds to S40, where it is determined whether or not the drone 3 has fallen within a preset set distance from the position of the customer 4. In this situation, if the drone 3 does not fall within the set distance from the position of the customer 4 (NO), the flow proceeds to S60, and it is determined whether or not there is an object that obstructs the flight ahead of the drone 3 in the flight direction by performing an image recognition processing on the image captured by the camera 23 of the drone 3.

Next, the flow proceeds to S70, where it is determined whether or not there is the obstacle in the flight direction of the drone 3. If there is no obstacle (NO), the flow returns to S60 to continue the flight and determine whether there is the obstacle (NO).

In S70, if there is the obstacle (YES), the flow proceeds to S80 in which the drone 3 determines whether or not to avoid the obstacle in the upward, leftward, or rightward direction based on the image of the obstacle. Then, the flow proceeds to S90, and the drone 3 continues to fly in the direction determined above. Thereafter, the flow returns to S20, the position is detected, the flight is continued, and the process described above is repeatedly executed.

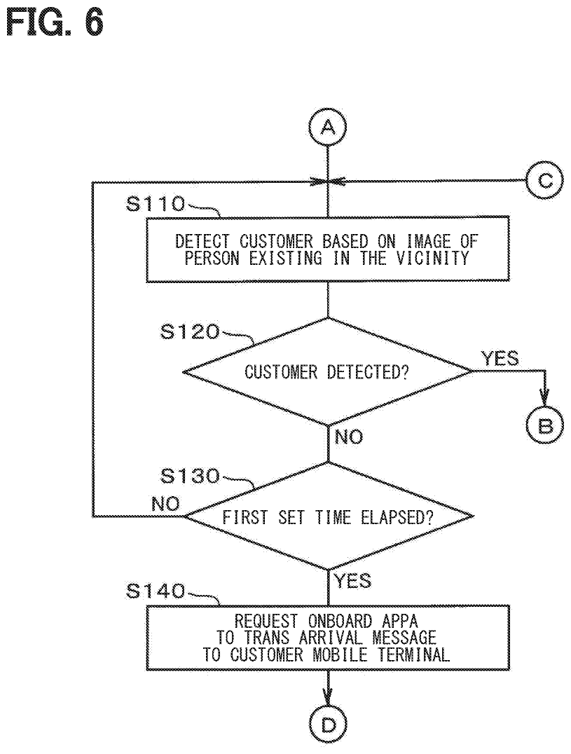

In S40, when the drone 3 falls within the set distance from the position of the customer 4 (YES), the flow proceeds to a control shown in a flowchart of FIG. 6. This control realizes a customer identification function, that is, a function of identifying, that is, detecting the customer based on the face image of the customer 4, and the present control will be described below. The flowchart of FIG. 6 shows the content of the control of the drone 3.

In S110 of FIG. 6, the drone 3 performs the image recognition processing on an image captured by the camera 23, that is, a face image of a person who exists in the vicinity of the drone 3, and compares the captured image with the face image of the customer 4, thereby determining whether or not the person who exists in the vicinity is the customer 4, that is, whether or not the customer 4 has been detected. Next, the flow proceeds to S120, and it is determined whether or not the customer 4 has been detected.

When the customer 4 has not been detected (NO), the flow proceeds to S130, and it is determined whether or not a first set time set in advance has elapsed from a start of the present control, that is, the customer detection control. If it is determined in

S130 that the first set time has not elapsed (NO), the flow returns to S110, where the customer 4 is continuously detected, and the process described above is repeatedly executed.

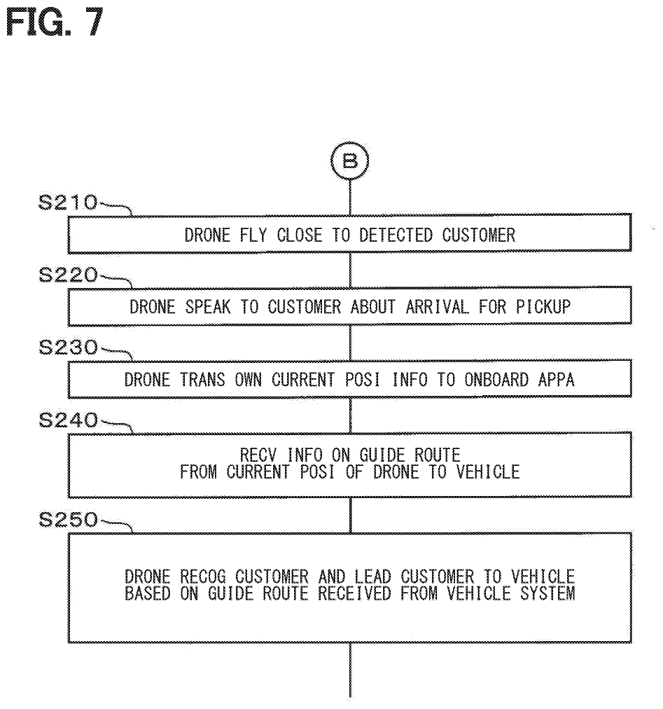

If it is determined in S120 that the customer 4 has been detected (YES), the flow proceeds to a control shown in a flowchart of FIG. 7. This control realizes a customer lead function, that is, a function of leading and guiding the customer 4 to the autonomous vehicle 2, and the present control will be described below. The flowchart of FIG. 7 shows the content of the control of the drone 3.

In S210 of FIG. 7, the drone 3 flies to the vicinity of the detected customer 4. Subsequently, the flow proceeds to S220, and the drone 3 speaks to the customer 4 about an arrival for pickup, for example, outputs a voice message indicative of the arrival for pickup from the speaker 22.

Next, the flow proceeds to S230, and the drone 3 transmits the current position information detected by the GPS receiver 27 of the drone 3 to the onboard apparatus 7. Then, when receiving the information of the current position of the drone 3, the onboard apparatus 7 calculates the guide route from the current position of the drone 3 to the autonomous vehicle 2, and transmits the information of the calculated guide route to the drone 3. In this case, it is preferable that the onboard apparatus 7 is configured to calculate a route guidance information for guiding along the guide route as necessary, and transmit the calculated route guidance information to the drone 3.

Thereafter, the flow proceeds to S240, and the drone 3 receives the “information on the guide route from the current position of the drone 3 to the autonomous vehicle 2 as well as the route guidance information as needed” calculated and transmitted by the onboard apparatus 7. Subsequently, the drone 3 advances to S250, and while detecting and recognizing the customer 4 by the customer image recognition, the drone 3 leads the customer 4 to the autonomous vehicle 2 along the guide route while speaking “here”, “turn right”, “turn left”, or the like while hovering a little ahead of the customer 4 (that is, keeping speaking at an effective distance) based on the received information on the guide route and the received information on the route guidance as needed.

After the drone 3 leads the customer 4 to the autonomous vehicle 2 and the customer 4 gets on the autonomous vehicle 2, the autonomous vehicle 2 performs autonomous driving toward a preset destination and carries the customer 4 to the destination. As the above-mentioned destination, for example, a nursing care service center, a hospital, a shop, or the like is set in accordance with a request of the customer 4. Further, when the customer 4 requests the vehicle dispatch center 1 to pick up the customer 4, the destination may be requested and set. In addition, after the customer 4 gets on the autonomous vehicle 2, the destination may be set in the vehicle.

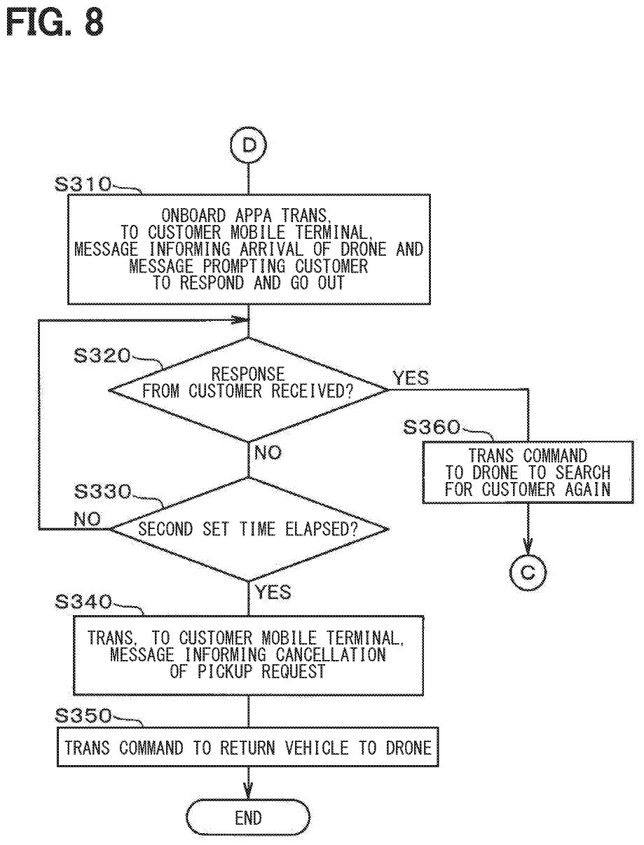

In S130 of FIG. 6, when the first set time has elapsed (YES), the flow proceeds to S140. In S140, the drone 3 transmits, to the onboard apparatus 7, information requesting the mobile terminal 5 of the customer 4 to transmit an arrival message informing the mobile terminal 5 of the customer 4 that the drone 3 has arrived. Thereafter, the flow proceeds to a control of the onboard apparatus 7 shown in a flowchart of FIG. 8.

In the control of the onboard apparatus 7, the arrival notice function, that is, a function of transmitting a message indicating that the drone 3 has arrived for pickup to the mobile terminal 5 of the customer 4 when the drone 3 cannot detect the customer 4 even if the drone 3 goes close to the customer 4, and requesting a response of approval to the customer 4 is realized, and this control will be described below. The flowchart of FIG. 8 shows the content of the control of the onboard apparatus 7.

In S310 of FIG. 8, the onboard apparatus 7 transmits, to the mobile terminal 5 of the customer 4, a message informing that the drone 3 has arrived in the vicinity of the customer 4, a message prompting the customer 4 to reply to this message, and a message prompting the customer 4 to leave a building. Subsequently, the flow proceeds to S320, and the onboard apparatus 7 determines whether or not to have received a reply from the mobile terminal 5 of the customer 4.

When the onboard apparatus 7 has received the reply from the mobile terminal 5 of the customer 4 (YES), the flow proceeds to S360. In S360, the onboard apparatus 7 transmits information instructing the drone 3 to search for the customer 4 again to the drone 3. Thereafter, the flow returns to S110 of FIG. 6, the onboard apparatus 7 detects the customer 4 again, and repeatedly executes the process described above.

When the onboard apparatus 7 has not received the reply from the mobile terminal 5 of the customer 4 in S320 (NO), the flow proceeds to S330. In S330, the onboard apparatus 7 determines whether or not a second set time set in advance has elapsed after executing the present control, that is, after executing the transmission process of S310. In S330, when the second set time has not elapsed (NO), the flow returns to S320, the onboard apparatus 7 continues the determination as to whether or not to have received the reply from the mobile terminal 5 of the customer 4, and repeatedly executes the process described above.

In S330, when the second set time has elapsed (YES), the flow proceeds to S340. In S340, since there has been no reply from the customer 4, the onboard apparatus 7 transmits a message to inform the customer 4 that the pickup request will be cancelled to the mobile terminal 5 of the customer 4. Subsequently, the flow proceeds to S350, and the onboard apparatus 7 transmits, to the drone 3, information instructing the drone 3 to return to the autonomous vehicle 2 and information on the current position of the autonomous vehicle 2 as required. The drone 3 is configured to return to the autonomous vehicle 2 upon receiving the return command.

In the present embodiment configured as described above, when the customer 4 requests the vehicle dispatch center 1 to pick up the customer 4 via the mobile terminal 5, the mobile terminal 5 transmits the pickup request, the position information, and the face image information of the customer 4 to the vehicle dispatch center 1, and the vehicle dispatch center 1 transmits the pickup command, the position information, and the face image information of the customer 4 to the autonomous vehicle 2. The autonomous vehicle 2 transmits the pickup command, the position information, and the face image information of the customer 4 to the drone 3, is autonomously driven to a position where the parking is allowed close to the customer 4, and launches the drone 3 at the parking position. The drone 3 is configured to detect the customer 4 by image recognition of the face image captured by the camera 23 which comes closer to the customer 4, and to lead the detected customer 4 to the autonomous vehicle 2. According to the above configuration, an unspecified number of customers 4 can be picked up by the autonomous vehicle 2 or the like for riding. In the case of the above-mentioned configuration, if the destination is set in the autonomous vehicle 2, the customer 4 who rides can be carried to the destination by autonomous driving. Furthermore, since the drone 3 only detects the customer 4 and leads the customer 4 to the autonomous vehicle 2, and does not carry a load, the drone 3 which is small enough to load the camera 23 and the speaker 22 can be used.

In the above embodiment, the autonomous vehicle 2 includes the autonomous driving apparatus 6 and the onboard apparatus 7, the onboard apparatus 7 communicates with the vehicle dispatch center 1, communicates with the drone 3, and communicates with the mobile terminal 5, and the autonomous driving apparatus 6 autonomously drives the autonomous vehicle 2 to the position commanded by the onboard apparatus 7. According to the above configuration, since the onboard apparatus 7 communicating with the vehicle dispatch center 1 and the like and the autonomous driving apparatus 6 autonomously driving the vehicle are separated from each other, the configuration is simplified.

In the above embodiment, the drone 3 includes the function of calculating the direction of the customer 4 from the current position based on the position information of the customer, the function of avoiding an obstacle if there is the obstacle when the drone 3 is flying toward the customer 4, the function of capturing a face image of a person in the vicinity of the customer with the camera 23 when the drone 3 flies to the vicinity of the customer 4, the function of detecting the customer 4 based on the captured face image, the function of notifying the detected customer 4 of arrival for pickup by voice, and the function of leading the customer 4 by voice while hovering a little ahead of the customer 4 along the guide route leading from the current position of the drone 3 to the autonomous vehicle 2. According to the above configuration, the drone 3 can pick up the customer 4, and lead the customer 4 to the autonomous vehicle 2.

In the embodiment described above, the onboard apparatus 7 is configured to transmit the message indicating that the customer 4 failed to detect and the message requesting the response to the mobile terminal 5 of the customer 4 when the drone 3 failed to detect the customer 4 even if the drone 3 has flied to the vicinity of the customer 4. According to the above configuration, the customer 4 can be notified of that the drone 3 failed to detect the customer.

In the above-described embodiment, the onboard apparatus 7 is configured to cancel the pickup and return the drone 3 to the autonomous vehicle 2 when there is no response from the customer 4 after transmitting the message requesting the response. According to the above configuration, when the customer 4 cannot be detected and there is no response from the customer 4, the pickup of the customer 4 can be stopped and the drone 3 can be returned to the autonomous vehicle 2.

In the above embodiment, after the autonomous vehicle 2 stops and flies the drone 3, when the autonomous vehicle 2 moves in accordance with the road situation, the onboard apparatus 7 is configured to transmit the information on the stop position after the movement to the drone 3. When the drone 3 thereafter detects the customer 4, the onboard apparatus 7 is configured to receive the information on the current position of the drone 3, calculate the guide route from the received current position of the drone 3 to the stop position of the autonomous vehicle 2, and transmit the information on the calculated guide route to the drone 3. According to the above configuration, the drone 3 can be surely returned to the autonomous vehicle 2 even when the autonomous vehicle 2 moves in accordance with the road situation after the drone 3 is caused to fly.

When the autonomous vehicle 2 moves while the drone 3 leads the customer 4 and returns to the autonomous vehicle 2, the onboard apparatus 7 is configured to transmit the information on the stop position after the movement to the drone 3, receive the information on the current position of the drone 3, calculate the guide route from the received current position of the drone 3 to the stop position of the autonomous vehicle 2, and transmit the information on the calculated guide route to the drone 3. According to the above configuration, even when the autonomous vehicle 2 moves according to the road situation in the case where the drone 3 is leading the customer 4, the drone 3 can surely return to the autonomous vehicle 2.

In the above embodiment, the guide route for leading the customer 4 to the autonomous vehicle 2 is calculated on the onboard apparatus 7 side, but instead, the guide route may be calculated on the drone 3 side. In the case of the above configuration, the drone 3 may be provided with a road map database, a function of calculating the guide route, and the like. The route guidance information is also calculated on the side of the onboard apparatus 7, but alternatively, the guide route may be calculated on the side of the drone 3.

Although the present disclosure has been described in accordance with the examples, it is understood that the present disclosure is not limited to such examples or structures. The present disclosure encompasses various modifications and variations within the scope of equivalents. In addition, various combinations and configurations, as well as other combinations and configurations that include only one element, more, or less, are within the scope and spirit of the present disclosure.

What is claimed is:

1. A pickup system comprising:
a vehicle dispatch center communicating with a mobile terminal carried by a customer;
an autonomous vehicle communicating with the vehicle dispatch center; and
a drone mounted on the autonomous vehicle, communicating with the autonomous vehicle, and having a camera, wherein
when a request to pick up the customer is inputted to the mobile terminal carried by the customer, the mobile terminal transmits, to the vehicle dispatch center, a pickup request of the customer, position information of the customer, and face image information of the customer,
the vehicle dispatch center transmits, to the autonomous vehicle, a pickup command of the customer, the position information of the customer, and the face image information of the customer,
the autonomous vehicle transmits, to the drone, the pickup command of the customer, the position information of the customer, and the face image information of the customer,
the autonomous vehicle autonomously drives to a position where a parking of the autonomous vehicle is allowed close to the customer, stops at the position, and launches the drone, and
the drone moves close to the customer, recognizes a face image captured by the camera to detect the customer, and guides the customer that is detected to the autonomous vehicle.

2. The pickup system according to claim 1, wherein
the autonomous vehicle includes an onboard apparatus and an autonomous driving apparatus,
the onboard apparatus communicates with the vehicle dispatch center, the drone, and the mobile terminal, and
the autonomous driving apparatus communicates with the onboard apparatus, and autonomously drives the autonomous vehicle to a position commanded by the onboard apparatus.

3. The pickup system according to claim 2, wherein
the drone is configured to:
calculate a direction toward the customer from a current position of the drone based on the position information of the customer;
avoid an obstacle existing in the direction toward the customer during a flight toward the customer;
capture one or more face images of one or more persons existing in a vicinity of the customer by the camera when the drone flies to the vicinity of the customer;
detect the customer based on the one or more face images that are captured;
notify the customer that is detected of an arrival for pickup by a voice guidance; and
guide the customer by the voice guidance by hovering slightly ahead of the customer along a guide route from the current position of the drone toward the autonomous vehicle.

4. The pickup system according to claim 3, wherein
the onboard apparatus is configured to transmit, to the mobile terminal carried by the customer, a message indicating a failure of customer detection and a message requesting a response when the drone fails to detect the customer after flying to the vicinity of the customer.

5. The pickup system according to claim 4, wherein
the onboard apparatus is configured to cancel a pickup of the customer and return the drone to the autonomous vehicle when no response is received from the customer after transmitting the message requesting the response.
